(19) United States
(12) Patent Application Publication
(10) Pub. No.: US 2007/0066130 A1
(43) Pub. Date: Mar. 22, 2007

(54) Cable and tip holder and data transmitting apparatus and method

(75) Inventors: Kenneth Mori, Los Angeles, CA (US); David A. Kleeman, Marina Del Rey, CA (US)

Correspondence Address: Allan W. Watts;Bryan Cave LLP, Suite 2200, Two North Central Avenue, Phoenix, AZ, 85004-4406, US

(73) Assignee: Belkin Corporation, Compton, CA (US)

(21) Appl. No.: 11/229,223

(22) Filed: Sep. 16, 2005

(51) Int. Cl. H01R 13/72

(52) U.S. Cl. 439/501

(57) ABSTRACT

An apparatus for transmitting data and a reusable structure for holding a data transmission unit such as a computer cable and a number of adapter tips configured to attach to different plug types. The cable may be wound around the structure, and the tips may be stored in recesses in the structure having at least three sides and at least one opening. The recesses may be parallel and the tips may be held in place with an interference or snap fit. The unit and tips may be held at least partially external to the structure, which may be a monolithic plastic body. Opposing substantially concave surfaces may be provided on opposite ends upon which to wind the cable. A method of providing cable connections includes providing the structure and teaching to wind the cable around the structure and to hold the tips at least partially within the structure.

### FIELD OF INVENTION

This invention generally relates to systems and methods for transmitting data between devices, and to structures for holding such systems.

### BACKGROUND OF THE INVENTION

Systems and methods have been developed to transmit data from a first device to a second device. As an example, cables have been used to transmit data from a computer to a printer, from one computer to another, from a computer to a projector, between a computer and an Internet connection, between a computer and a still or motion camera, between a computer and a storage device, and the like. Cables have also been used to make connections to scanners, personal digital assistants (PDAs), telephones such as mobile phones, speakers, and modems, as further examples. However, a number of different types of plugs are found on such devices and in the past it has been necessary to have different cables with different ends, connectors, or connections to use with different devices. To avoid the need to have many different cables, adaptor tips have been used that convert from one type of connector or plug to another.

However, it can be difficult to efficiently manage a number of different components, for example, a cable and a number of different adapter tips. Therefore, a need exists for a structure or apparatus for holding such components, and for a kit that includes both the components and the holder. Further, needs and potential for benefit exists for such a holder or kit that is inexpensive to manufacture, small, light weight, or has a combination of these properties. Even further, needs and potential for benefit exists for such a holder or kit that organizes the various components in a manner such that the user can easily identify and access the needed components, return components to the holder, determine whether components are missing, or a combination thereof. Potential for improvement exists in these and other areas that may be apparent to a person of skill in the art having studied this document.

### SUMMARY OF PARTICULAR EMBODIMENTS OF THE INVENTION

Embodiments of this invention include methods, systems, kits, and apparatuses for transmitting data between devices (e.g., computers, and electronic peripheral devices), holding data transmission units such as cables, and holding a number of adapter tips configured to attach to the transmission unit or cable and to plugs on the devices. Different embodiments of the invention may transmit or facilitate the transmission of data, or may hold an apparatus that transmits of facilitates the transmission of data. Particular embodiments may include or hold a cable and a plurality of tips for the cable.

Various embodiments of the invention provide as an object or benefit that they partially or fully address one or more of the needs, potential areas for improvement, and functions described herein, for instance. The present invention provides various embodiments that may be more useful, less complex, less costly, more convenient, more manageable, smaller, more reliable, or a combination thereof, in comparison with various prior art. Further features and advantages of the invention may be apparent to those skilled in the art.

In a specific embodiment, the invention provides an apparatus for transmitting data between a first device and a second device. The apparatus may include a data transmission unit which may have a first connector and a second connector, and the unit may be configured to transmit data from the first connector to the second connector. The apparatus may also include a plurality of tips configured to attach to at least one of the first connector and the second connector, and the plurality of tips may be configured to connect to and facilitate exchange of data through a plurality of types of plugs that may be present at the first device, the second device, or both. Such an apparatus may further include a reusable structure configured to hold both the unit and the plurality of tips. In some embodiments, the first device, the second device, or both, may be a computer, for example.

In particular embodiments, the data transmission unit consists essentially of a cable which may have a first end and a second end, and the first end may include the first connector described above, and the second end may include the second connector. Further, in some embodiments, the structure, which may consist essentially of a monolithic plastic body, may be configured so that the cable may conveniently be wound around the structure. The structure may include a plurality of recesses configured to hold the plurality of tips, and in certain embodiments, a recess may be provided for each of the plurality of tips, which may be configured to hold the tips via an interference fit, a snap fit, or a combination thereof. In particular embodiments, the unit and the tips may be held at least partially external to the structure.

In another specific embodiment, this invention provides an apparatus for holding a cable and a plurality of adaptor tips configured to attach to at least one end of the cable. The cable may be a computer cable, for instance, and in particular embodiments, the plurality of tips may comprise at least two of a male A tip, a female A tip, a male B tip, a male mini B tip, and a male mini A tip, for example. The apparatus, which may consist essentially of a monolithic plastic body, may include recesses as mentioned above, and opposing surfaces configured for the cable to be wound around, which may be substantially concave surfaces in certain embodiments. Yet another specific embodiment of this invention provides an apparatus for a similar purpose that includes a combination of a monolithic plastic body with opposing substantially concave surfaces on opposite ends and a plurality of recesses between the ends, which each have at least three sides and at least one opening. In some embodiments, these recesses may be substantially parallel.

In still another specific embodiment, this invention provides a method of providing cable connections between a plurality of different plug types. The method may include providing a reusable structure configured to hold a cable wound around the structure and configured to hold a plurality of tips configured to be attached to the cable. The structure may be similar to the structure or body described above, and the tips may be similar to those described above, as examples. In some embodiments, the structure may be configured to hold the tips at least partially within the structure. The method may also include providing the cable wound around the structure, providing an image of the cable wound around the structure, providing an instruction to wind the cable around the structure, or a combination thereof. The method further may include providing the plurality of tips at least partially within the structure, providing an image showing the tips at least partially within the structure, providing an instruction to store the tips at least partially within the structure, or a combination thereof.

### BRIEF DESCRIPTION OF THE DRAWINGS

The figures in this document illustrate various exemplary embodiments of the present invention, wherein like reference numerals represent like elements. Embodiments of the invention may include part or all of the features shown in one of these drawings, or may include features from two or more figures. Accordingly,

FIG. 1 is an isometric view illustrating an exemplary embodiment of an apparatus in accordance with the invention that includes a structure or body, a cable wound around the body, and a plurality of adapter tips configured to attach to the cable;

FIG. 2 is an isometric view of the structure or body of the embodiment illustrated in FIG. 1, which may serve as an apparatus for holding the cable and the plurality of adapter tips;

FIG. 3 is a side view of the apparatus shown in FIG. 1 and the structure or body shown in FIG. 2 which includes the adapter tips but not the cable;

FIG. 4 is an isometric view illustrating an alternate embodiment of the structure or body that includes recesses for only two adaptor tips;

FIG. 5 illustrates an alternate embodiment of the invention having four adapter tips on one side of the structure or body; and

FIG. 6 is a flow chart illustrating an example of a method of providing cable connections between different plug types in accordance with the invention.

### DETAILED DESCRIPTION OF EMBODIMENTS

Various embodiments of the invention include systems, apparatuses, and methods for transmitting data, for example, between devices. In addition, certain embodiments of the invention provide a reusable structure for holding a data transmission unit such as a cable, and a number of adapter tips configured to attach to different plug types. Such a cable may be a computer cable, for instance, and may be used to connect a computer to one or more of a number of peripheral devices. In a number of different embodiments, the cable may be wound around the structure, which may be configured specifically for that purpose, and the tips may be stored in recesses in the structure in certain embodiments. In particular embodiments, these recesses may have at least three sides and at least one opening. The recesses may be parallel or substantially parallel in different embodiments, and, in some embodiments, the tips may be held in place within the structure or body by an interference or snap fit. In many embodiments, the unit and tips may be held at least partially external to the structure. This structure may, in some embodiments, be a monolithic plastic body. Opposing surfaces may be provided on opposite ends of the structure upon which to wind the cable, and these surfaces may be concave or substantially concave in various embodiments. Methods of providing cable connections in accordance with the invention, for example, between devices, may include providing the structure or body and teaching a user or potential user to wind the cable around the structure and to store or hold the tips at least partially within the structure.

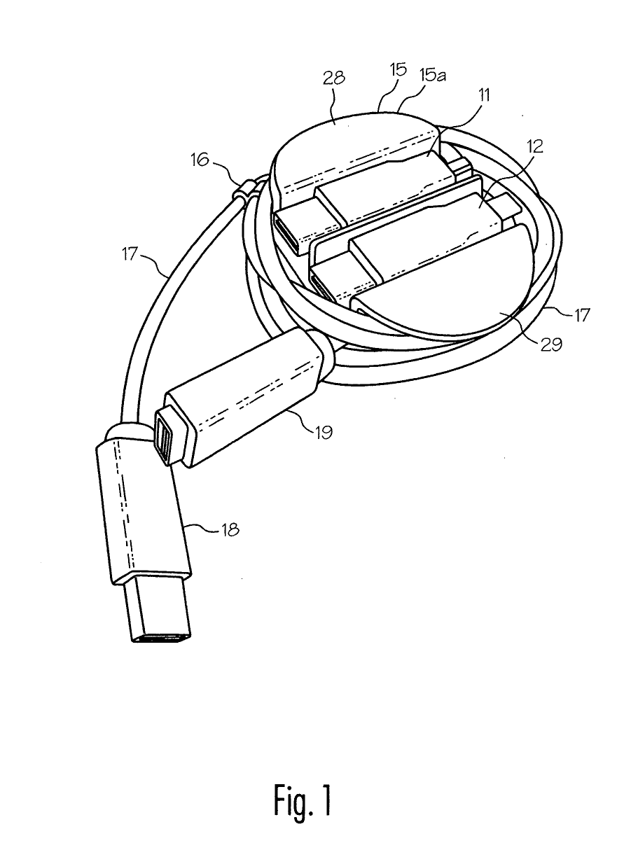

Looking now at particular embodiments, FIG. 1 illustrates an example of the invention that includes structure or body 15, adapter tips 11 and 12, and cable 17. In the illustration, cable 17 includes ends or connectors 18 and 19, and is an example of a data transmission unit. Other examples of data transmission units may include wireless communications, for example, via radio telemetry, infra red signals, microwave signals, light, or the like. In many embodiments, a data transmission unit such as the cable 17 that is illustrated is configured to transmit data from connector 18 to connector 19, for example, vice versa, or both (i.e., in both directions). In many embodiments, cable 17 may include a plurality of metal conductors or wires and insulation. In some embodiments, cable 17 may include shielding. In many embodiments, cable 17 may be a computer cable. And in some embodiments, cable 17 may be a fiber optic cable. Cable 17 may be 2 or 3 meters long, for example.

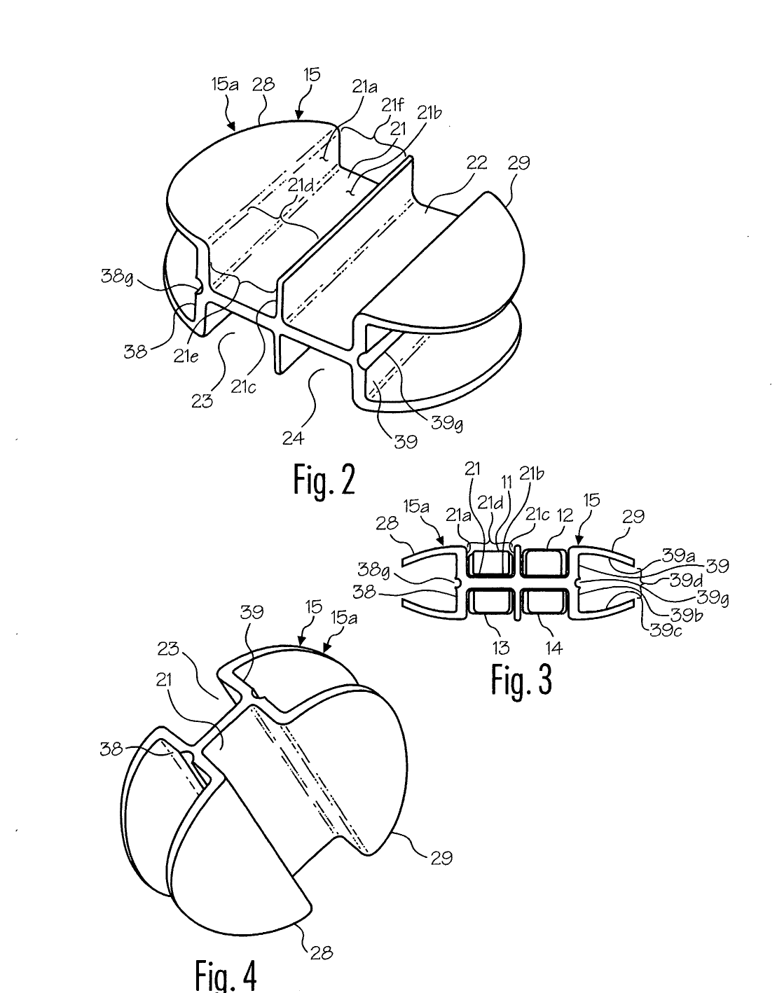

FIG. 2 shows the example of structure or body 15 shown in FIG. 1, (embodiment 15a) without cable 17 or tips, for example, tips 11 an 12. In addition, FIG. 3 is a side view of this same embodiment 15a of body 15, which illustrates, among other things, that tips 13 and 14 may be provided on the other side of body 15 from what is shown in FIG. 1. FIG. 3 illustrates tips 11-14, but not cable 17, which has been omitted for clarity.

Tips 11, 12, 13, and 14 may be configured to attach to one or both of connectors 18 and 19 of cable 17, and these tips may be configured to connect to different types of plugs, for example, that may be present on various devices between which cable 17 and the appropriate tips 11-14 may provide for or facilitate transmitting data. As examples, one of the devices to which cable 17 or one of the tips 11-14 may attach may be a computer, such as a desk top personal computer (PC) or a laptop computer. The other device may be another computer or a projector, an Internet connection, a still or motion camera, a storage device, a scanner, a PDA, a telephone, a mobile phone, a speaker, a modem or the like, as examples. The data transmission unit, such as cable 17, and at least one of tips 11-14 may facilitate the exchange of data between the two devices, such as a computer and another device, through plugs present on the devices. Different devices may have different types of plugs, and different tips 11-14 may facilitate the exchange of data (in one direction or both) between such devices.

Referring still to FIG. 1, in various embodiments, connectors 18 and 19 on cable 17, for example, may be universal serial bus (USB) connectors or may be proprietary connectors. Tips 11-14, for example, may each be configured to attach to at least one of connectors 18 and 19 on one end of the tips, and the other end of tips 11-14 may provide a connection, for example, to a plug on a device to which cable 17 may be attached. In many embodiments, each connection to a plug may have one or more pins, for example, for forming an electrical connection. Various connections to different plugs may have 1, 2, 3, 4, 5, 6, 7, 8, 9, 10, or 12 pins, for example. Similarly, cable 17 may have 1, 2, 3, 4, 5, 6, 7, 8, 9, 10, or 12 conductors, although the number of pins on one or both ends of tips 11-14 will not necessarily be the same as the number of conductors in cable 17. Connections to the different plugs may differ as to both the number of pins and the arrangement of pins. Spacing of pins may also differ for different tips 11-14.

In specific examples, tips 11-14 may provide a male A connection, a female A connection, a male B connection, a male mini B connection, a male mini A connection, or a combination of these. In some embodiments, tips 11-14 may include Firewire connections. In some embodiments, tips 11-14 may include telecom related RJ-11 or RJ-45 connectors, as other examples. In some embodiments, some or all of tips 11-14 may have different connections on at least one end of the tips to facilitate connecting to different types of plugs on the devices with which the invention may be used. In some embodiments, at least two different connections (to different types of plugs) may be provided among tips 11-14. In particular embodiments, at least three different connections may be provided among tips 11-14. In some embodiments, each of tips 11-14 may provide a different connection to a different type of plug.

Tips 11-14 may include a label indicating the type of connection that they provide or the type of plug that they connect to. In some embodiments, different tips having different connections for different plugs may be color coded, identified by a symbol, identified by size, or the like. The embodiment of body 15 that is illustrated in FIG. 1-3, which may be referred to as embodiment 15a, has the ability to hold four different tips 11-14. Other embodiments of body 15 may hold a different number of tips, such as 2 (see FIG. 4, for example), 3, 5, 6, 7, 8, 10, or 12, for example.

As mentioned, FIG. 2 shows the example of structure or body 15 shown in FIG. 1, (embodiment 15a) without cable 17 or tips 11-14. The embodiment of body 15 illustrated includes recesses 21, 22, 23, and 24, which, in this embodiment, are configured to hold tips 11, 12, 13, and 14 illustrated in FIG. 3, for example. FIG. 3 is a side view of this same embodiment 15a of body 15, showing tips 11-14 in recesses 21-24, but not showing cable 17. Focusing on recess 21 as an example, recess 21 includes side 21a, bottom 21b, and side 21c, which are all formed by surfaces of body 15. Recess 21 is also defined by opening 21d and openings 21e and 21f. Thus, recess 21 is defined by body 15 on three sides and openings on three sides. As illustrated, the shapes of recesses 22-24 may be essentially identical or similar, and in the embodiment illustrated, recesses 21-24 are parallel or substantially parallel. As used herein, substantially parallel means parallel to within 10 degrees.

In the embodiment illustrated, embodiment 15a, tips 11-14 are said to be held at least partially external to structure or body 15 since at least one of sides 21d, 21e, and 21f are open. In other words, openings 21d, 21e, and 21f are not covered by a lid, for example. However since tip 11, for example, is at least partially below opening 21d, tip 11 is said to be at least partially within structure or body 15. The same would be true for the other tips 12-14 in the embodiment that is depicted.

Still referring to FIG. 3, tip 11 may have a slightly larger dimension than the dimension between sides 21a and 21c when tip 11 and body 15 are relaxed such that tip 11 fits within recess 21 with an interference fit. In many embodiments, this interference fit holds tip 11 within recess 21. In a number of embodiments, the same may be the case for the other tips and recesses. In some embodiments the various tips may have different dimensions and may be stored in different size recesses. In other embodiments, the tips 11-14, for example, may all have at least one dimension in common and may all fit (and may be held) within the same size recess. In such embodiments, recesses 21-24 may all have essentially the same dimension (e.g., from side 21a to side 21c).

In other embodiments, side 21a, side 21c, or both, may have indentations or projections, and tip 11 may fit into recess 21 with a snap fit, for example. In such embodiments, the other recesses 22-24 and the other tips 12-14 may fit similarly and in some embodiments, each of the tips may be held in a recess.

Body 15 may be made of a polymer or plastic, and may be formed in one piece (i.e., monolithic), for example, by molding or by extrusion. Body 15 may be made of a thermal plastic or a thermal set plastic, for instance. In particular embodiments, body 15 may be made of polypropylene. Body 15 may be reusable, and may be configured so that tips 11-14, for example, may be removed and reinserted into recesses 21-24 repeatedly, each time being held in place by an interference or snap fit, for example. As used herein, the term “reusable” does not refer to packaging that is typically discarded when a product is first used.

In various embodiments, body 15 may be configured to hold a data transmission unit such as cable 17 illustrated in FIG. 1. As shown, cable 17 may wind around body 15 and tips 11-14, for instance, may be stored on or within body 15, for example, as shown. In certain embodiments, structure or body 15 may be specifically configured for cable 17 to be wound around structure or body 15. In certain embodiments, body 15 may have opposing surfaces for cable 17 to be wound around. As an example, the embodiment 15a of body 15 illustrated in FIGS. 1-3 includes ends 28 and 29 which include opposite surfaces 38 and 39 configured for cable 17 to be wound around. In this embodiment 15a, surfaces 38 and 39 are configured to contact cable 17.

Referring to FIG. 3, and specifically to end 29 of body 15, in embodiment 15a, surface 39 includes side 39a, bottom 39b, and side 39c. As illustrated, top 39d is open. As used herein, a surface is said to be substantially concave if a majority of the surface is concave, or if the surface is comprised of a plurality of flat or concave surfaces arranged in a concave pattern. In the embodiment 15a illustrated, side 39a, bottom 39b, and side 39c are arranged in a concave pattern. Consequently, surface 39 is said to be substantially concave. In embodiment 15a, the same is the case for opposite opposing surface 38 at end 28 of body 15.

In particular embodiments, surface 38 and surface 39 include grooves 38g and 39g as illustrated in FIGS. 2 and 3, for example. When cable 17 is wound onto structure or body 15, the first winding of cable 17 may be laid in grooves 38g and 39g. Grooves 38g, 39g, or both may help to anchor the end of cable 17, for example, prior to winding it around body 15. Grooves 38g, 39g, or both may make it easier to initiate winding, may keep the bundle of cable 17 compact, or both, for instance. Referring to FIG. 1, in certain embodiments, a clip 16 may be provided to keep cable 17 from unwinding before or to a greater extent than intended.

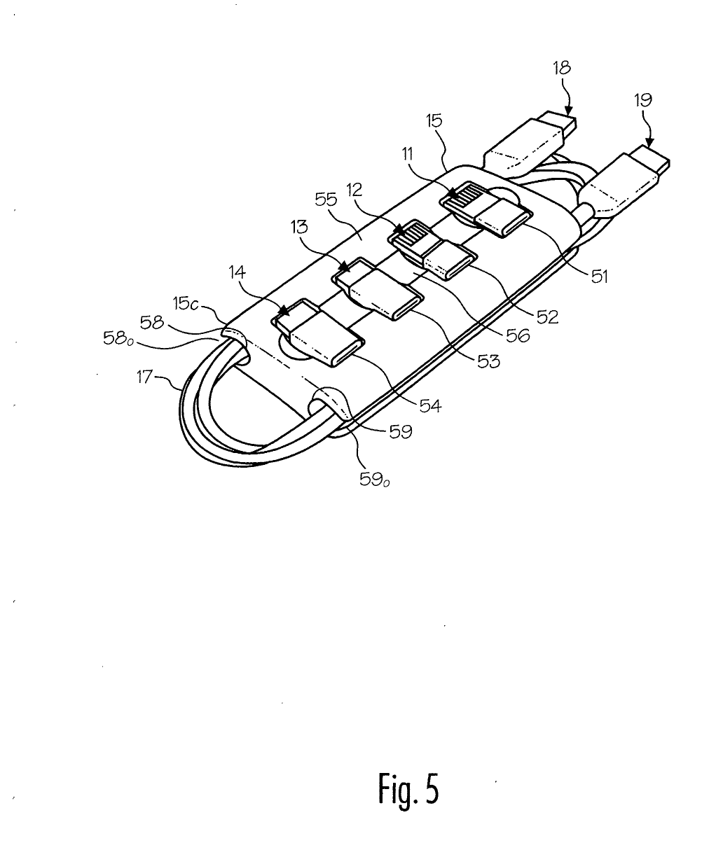

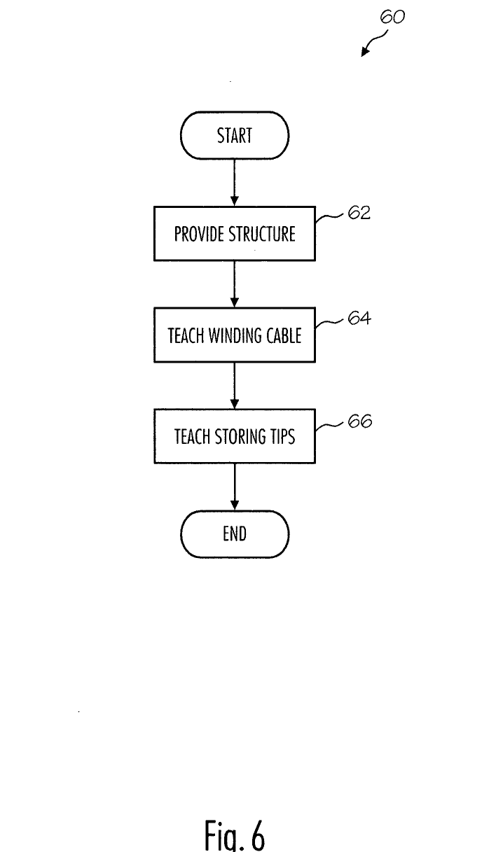

Alternate embodiments of body 15 are illustrated in FIGS. 4 and 5, both of which are configured to hold both a data transmission unit, specifically cable 17, and a plurality of tips, for example, adaptor tips. FIG. 4 illustrates an alternate embodiment of structure or body 15, embodiment 15b, that has only two recesses 21 and 23. Thus, embodiment 15b is configured to hold two tips, for example, two of tips 11-14. FIG. 5 illustrates another alternate embodiment of body 15, embodiment 15c, wherein tips 11, 12, 13, and 14 are stored on one surface 55 of body 15. Note that in this embodiment, embodiment 15c, tips 11-14 may be parallel (as shown) or substantially parallel. In some embodiments, more tips may be stored on the other side of body 15, for example, parallel to tips 11-14 shown. Embodiment 15c may be plastic, and may be monolithic, as described for other embodiments of body 15.

In embodiment 15c, tips 11-14 are stored in recesses 51, 52, 53, and 54. Recesses 51-54 may be configured to hold tips 11-14, and may have five sides (e.g., bottom, right, left, front, and back) and one opening (e.g., top). Tips 11-14 may be held within recesses 51-54 with an interference fit or snap fit, for example. Embodiment 15c includes groove 56 to facilitate removal of tips 11-14 from recesses 51-54. As illustrated, embodiment 15c of body 15 includes surfaces 58 and 59 which are configured to contact cable 17. As illustrated, in embodiment 15c, surfaces 58 and 59 are opposite to each other and are concave. As in embodiments 15a and 15b, embodiment 15c and surfaces 58 and 59 specifically, are configured for cable 17 to be wound around structure or body 15, as shown. Further, as used herein, tips 11-14 and cable 17 are at least partially external to embodiment 15c of structure or body 15.

The invention also includes various methods which may be used in conjunction with structures or apparatuses in accordance with the invention, for example, as described herein. Methods in accordance with the invention include methods of providing connections between different types of plugs, for example, between devices. Such connections, may be used to transmit data between electrical devices, for instance. In a specific example, FIG. 6 illustrates a method 60 in accordance with the invention. Method 60 may be a method of providing connections between different plug types, which may be accomplished using a data transmission unit or cable, and a plurality of adaptor tips for the different plug types. Method 60 includes providing a structure configured to hold a cable wound around the structure and configured to hold a plurality of tips that are configured to be attached to the cable (step 62). In many embodiments, the tips may be configured to be electrically attached to the cable and to an electrical device or plug. The structure may be reusable, and may be configured to hold the tips at least partially within the structure, for example, as illustrated in FIGS. 1-5. Further, in some embodiments, the structure may have recesses configured to hold the tips, for example, as described herein, may have substantially concave surfaces configured to contact the cable, or both.

Method 60 may also include steps that teach a user how to use the structure. For example, method 60 may include the step of teaching a user to wind the cable around the structure (step 64). This may include, for example, providing instructions to wind the cable around the structure, providing an image, such as a drawing or photograph, of the cable wound around the structure, or providing the cable wound around the structure so that the user can see how to wind the cable. In some embodiments, the teaching of winding the cable may be accomplished in more than one way. For instance, teaching to wind the cable may be accomplished with a combination of providing the cable wound around the structure or body and advertising that the cable can be stored by being wound around the structure.

Method 60 may also include a step of teaching the user to store the tips within the structure (step 66). This may include, for instance, providing instructions to store the tips with in the structure, which may be in writing, for example, providing an image showing the tips at least partially within the structure, or providing the tips within the structure so that the user can see where they are stored. In some embodiments, more than one of these steps of teaching may be employed. For instance, teaching to store the tips may be accomplished with a combination of providing the tips in or on the structure or body and advertising that the tips can be stored in or on the structure. Instructions or images may be provided on the packaging, in instruction sheets, or the like.

The detailed description of examples of embodiments herein makes reference to the accompanying drawings, which show examples of embodiments by way of illustration and its best mode. While these examples of embodiments are described in sufficient detail to enable those skilled in the art to practice the invention, it should be understood that other embodiments may be realized and that logical changes may be made without departing from the spirit and scope of the invention. Thus, the detailed description herein is presented for purposes of illustration only and not of limitation. For example, unless stated otherwise, the steps recited in the method or process descriptions may be executed in any order and are not limited to the order presented.

Further, benefits, other advantages, and solutions to problems have been described herein with regard to specific embodiments. However, the benefits, advantages, solutions to problems, and element(s) that may cause benefit, advantage, or solution to occur or become more pronounced are not to be construed as critical, required, or essential features or elements of the claims or the invention. Reference to an element in the singular is not intended to mean “one and only one” unless explicitly so stated, but rather “one or more.” As used herein, the terms “comprises”, “comprising”, or a variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical”.

1. An apparatus for transmitting data between a first device and a second device, the apparatus comprising:
a data transmission unit having a first connector and a second connector wherein the unit is configured to transmit data from the first connector to the second connector;
a plurality of tips configured to attach to at least one of the first connector and the second connector, the plurality of tips being configured to connect to and facilitate exchange of data through a plurality of types of plugs that may be present at least one of the first device and the second device; and
a reusable structure configured to hold both the unit and the plurality of tips;
wherein the structure comprises a plurality of recesses configured to hold the plurality of tips via at least one of an interference fit and a snap fit.

2. The apparatus of claim 1 wherein the data transmission unit consists essentially of a cable having a first end and a second end wherein the first end comprises the first connector and the second end comprises the second connector.

3. The apparatus of claim 2 wherein the structure is configured for the cable to be wound around the structure.

4. The apparatus of claim 1 wherein the cable tips are located in the recesses.

5. The apparatus of claim 4 wherein the cable is wound around the structure.

6. The apparatus of claim 1 wherein at least one of the first device and the second device is a computer.

7. The apparatus of claim 1 wherein the unit and the tips are held at least partially external to the structure.

8. The apparatus of claim 1 wherein the structure consists essentially of a monolithic plastic body.

9. An apparatus for holding a cable and a plurality of adaptor tips configured to attach to at least one end of the cable, the apparatus comprising:
a body;
a plurality of recesses configured to hold the plurality of tips wherein each recess is defined by the body on three sides and is defined by openings on three sides; and
the body further defines opposing surfaces configured for the cable to be wound around.

10. The apparatus of claim 9 wherein the recesses are configured to hold the tips via at least one of an interference fit and a snap fit.

11. The apparatus of claim 9 wherein the opposing surfaces are substantially concave.

12. The apparatus of claim 9 further comprising the cable wherein the cable is a computer cable.

13. The apparatus of claim 9 further comprising the plurality of adaptor tips wherein the plurality of tips comprise at least two of a male A tip, a female A tip, a male B tip, a male mini B tip, and a male mini A tip.

14. The apparatus of claim 9 further comprising the tips and cable wherein the tips are located within the recesses and the cable is wound around the body.

15. A method of providing cable connections between a plurality of different plug types, the method comprising in any order at least the steps of:
providing a reusable structure configured to hold a cable wound around the structure and configured to hold a plurality of tips configured to be attached to the cable, wherein the structure is configured to hold the tips at least partially within the structure;
at least one of:
providing the cable wound around the structure,
providing an image of the cable wound around the structure, and
providing an instruction to wind the cable around the structure; and
at least one of:
providing the plurality of tips at least partially within the structure,
providing an image showing the tips at least partially within the structure, and
providing an instruction to store the tips at least partially within the structure.

16. The method of claim 15 wherein the step of providing the reusable structure includes providing a plurality of recesses configured to hold the plurality of tips.

17. The method of claim 16 wherein the recesses are substantially parallel and are configured to hold the tips via at least one of an interference fit and a snap fit.

18. The method of claim 15 comprising the step of providing at least two of a male A tip, a female A tip, a male B tip, a male mini B tip, and a male mini A tip.

19. The method of claim 15 wherein the step of providing the reusable structure includes providing a structure consisting essentially of a monolithic plastic body and having opposing substantially concave surfaces configured to contact the cable.

20. An apparatus for holding a cable and a plurality of adaptor tips configured to attach to at least one end of the cable, the apparatus comprising a monolithic plastic body having opposing substantially concave surfaces on opposite ends and a plurality of recesses between the ends, each recess having at least three sides and at least one opening wherein the recesses are configured to hold the plurality of tips via at least one of an interference fit and a snap fit when the tips are not attached to the cable.

21. The apparatus of claim 20 wherein the recesses are substantially parallel.
